(19) United States
(12) Patent Application Publication
(10) Pub. No.: US 2021/0367881 A1
(43) Pub. Date: Nov. 25, 2021

(54) Dynamic Multihoming Management System for Reliable Data Transmission in a Robotic System

(71) Applicant: Fort Robotics, Inc., Philadelphia, PA (US)

(72) Inventor: Nathan Bivans, Philadelphia, PA (US)

(21) Appl. No.: 17/326,878

(22) Filed: May 21, 2021

Related U.S. Application Data
(60) Provisional application No. 63/028,291, filed on May 21, 2020.

(51) Int. Cl. H04L 12/725; B25J 9/16; B25J 13/00; H04L 12/26; H04L 12/707

(52) U.S. Cl. CPC H04L 45/302; B25J 9/1674; H04L 45/22; H04L 45/306; H04L 43/08; B25J 13/006

(57) ABSTRACT

A dynamic multihoming management system for reliable data transmission in a robotic system. The system maintains links for data transmission between nodes. Data is categorized into different classes each associated with a set of requirements for data transmission. A first data class is functional safety data associated with a first set of requirements including a latency level below a first threshold. A second data class is associated with a second set of requirements. The system determines a set of links that satisfy the first set and the second set of requirements and selects a link as an active link to transmit data. The system monitors link status by calculating fitness metrics using different combination of factors for each class of data. Responsive to detecting a degradation in quality of the active link, the system determines to select a new active link for transmitting the safety data based on fitness metrics.

### CROSS-REFERENCE TO RELATED APPLICATIONS

The present application claims the benefit of U.S. Provisional Patent Application No. 63/028,291 filed on May 21, 2020, which is hereby incorporated by reference in its entirety.

### TECHNICAL FIELD

The disclosed embodiments generally relate to robotics, and particularly to a dynamic multihoming management system for reliable data transmission in a robotic system.

### BACKGROUND

Using robots and other machines in a workplace may improve efficiency and may help accomplish tasks that humans may not be able to perform. However, these machines can also be fast and powerful and may cause injuries or hazards, and therefore, safety is especially critical in the use of robots in workplace. Functional safety requirements mandate that communications between such robots for safety messages must meet onerous requirements for reliability, such that error in communications is highly detectable, and a likelihood of being unable to detect error in these communications is extremely low. Reliability of many data communication links, such as wireless and non-wireless links, are subject to degradation for a variety of reasons (e.g., network traffic congestion, devices are out of optimal range from one another, etc.). To address this issue while meeting functional safety standards, existing systems use rigid, inflexible data channels to communicate safety information. This solution, however, is not scalable to larger facilities, and results in network inefficiencies where links are used sub-optimally.

### SUMMARY

Systems and methods are disclosed herein for operating a dynamic multihoming management system for reliable data transmission in a robotic system. In one embodiment, the multihoming management system may maintain a plurality of links for data transmission between nodes, where the plurality of links includes one or more active links and a set of backup links. The data to transmit may be categorized into different classes of data, and each class of data may be associated with a set of requirements for the quality of link used to transmit the class of data. A first class of data may be functional safety data that is associated with a first set of requirements, such as requiring a latency level below a first threshold. A second class of data may be another class of data that is associated with a second set of requirements, requiring a latency level below a second threshold that is higher than the first threshold. The multihoming management system may determine a set of links that satisfy the first set and the second set of requirements and select a link as an active link to transmit data for both the first and the second classes of data. Other links in the set of links may be referred to as backup links. Multihoming management system may monitor status of the active link and the backup links by calculating fitness metrics for the links. The fitness metrics may be calculated using different combination of factors for each class of data, where the factors may include signal strength, bandwidth, error rates, latency, power efficiency, system configuration, and timing of last link transition, etc. As different classes of data have different demands for the quality of links for data transmission, the fitness metrics may be calculated differently for each class of data.

In one embodiment, quality of links may change over time and quality of the links may be monitored by the multihoming management system. Responsive to detecting a degradation in quality of the active link, the multihoming management system may determine that the active link no longer meets the first set of requirements for transmitting safety data. Multihoming management system may select from the set of backup links, a new active link for transmitting the safety data. The new active link is selected based on fitness metrics of the links based on requirements of safety data. In one embodiment, multihoming management system may determine that the original active link may still be a link suitable for transmitting the second type of data. The determination may be based on a fitness metrics of the original active link determined based on requirements of the second class of data, and therefore, the original active link may still be used for transmitting the second class of data while the new active link is used for transmitting the first class of data.

The systems and methods disclosed herein provide various technical advantages. For example, the systems and methods disclosed herein improves reliability of safety data transmission by maintaining multiple connections. For example, as safety data may be sensitive to network interruptions, if the quality of a link that transmits safety data drops and no longer meets the requirements associated with the safety data (e.g. latency requirement or bandwidth requirement), the multihoming management system may leverage between multiple links to activate a new link that meets the requirements. Furthermore, the multihoming management system may select a link based on a set of parameters and the system may determine various combinations of parameters based on different classes of data. For example, the system may transmit safety data (which may require stable connection with minimal latency) over ISM which is reliable but has narrow bandwidth and transmit informational data through Wi-fi which has sufficient bandwidth but may not be as reliable. Even more, the system improves power efficiency and saves resources by periodically monitoring the different links, allowing flexibility to use a most efficient link while ensuring compliance with functional safety standards. The system may perform link transition if the data transmission for a data class does not require such a high speed or bandwidth. For example, informational information that is being transmitted using LTE (Long Term Evolution) because Wi-fi was not available previously may be transitioned to a Wi-fi connection if a Wi-fi portal is available, because Wi-fi may be more power efficient than LTE connection. Further, the disclosed systems and methods are dynamic and adaptable to changes in system environments, such as robots/machines moving out of range of control in a large facility. The disclosed systems and methods provide a solution that maintains functional safety requirements by leveraging multiple links for communication with robots dynamically by monitoring various links with different characteristics.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 shows a diagram of a system environment of a multihoming management system, according to one embodiment.

FIG. 2 shows an exemplary system including two nodes, various interfaces and links that connect the two nodes, according to one example embodiment.

FIG. 3 shows a block diagram of a multihoming management system, according to one example embodiment.

FIG. 4 shows an exemplary system and method of an iterative process performed by the multihoming management system, according to one example embodiment.

FIG. 5 shows an exemplary system and method of selecting a link responsive to changes in link qualities, according to one example embodiment.

The figures depict various embodiments of the present invention for purposes of illustration only. One skilled in the art will readily recognize from the following description that other alternative embodiments of the structures and methods illustrated herein may be employed without departing from the principles of the invention described herein.

### DETAILED DESCRIPTION

### System Overview

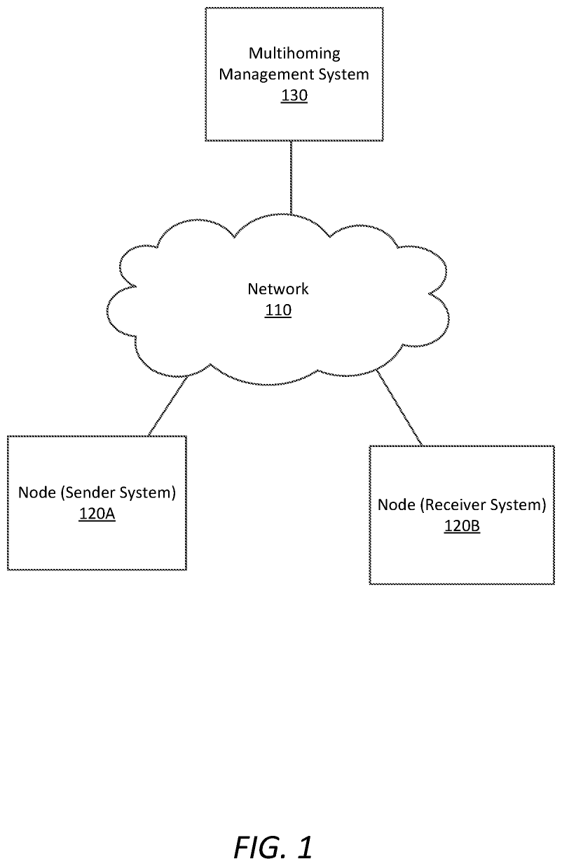

FIG. 1 shows a system environment including a multihoming management system 130, network 110, nodes 120A and 120B. Multihoming management system 130 manages multiple links for data transmission between nodes 120A and 120B.

The network 110 may be any suitable communications network for data transmission. In one embodiment, network 110 may use standard communications technologies and/or protocols. Network 110 can include links using technologies such as Ethernet, 802.11, worldwide interoperability for microwave access (WiMAX), 3G, 4G, 5G, long term evolution (LTE), digital subscriber line (DSL), asynchronous transfer mode (ATM), InfiniBand, PCI Express Advanced Switching, Bluetooth, near field communication (NFC), ISM (Industrial, Scientific, Medical), radio, etc. Similarly, the networking protocols used on network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over network 110 can be represented using technologies and/or formats including the hypertext markup language (HTML), the extensible markup language (XML), JavaScript Object Notation (JSON), etc. In addition, all or some of links can be encrypted using conventional encryption technologies such as the secure sockets layer (SSL), transport layer security (TLS), virtual private networks (VPNs), Internet Protocol security (IPsec), etc. In another embodiment, the entities use custom and/or dedicated data communications technologies instead of, or in addition to, the ones described above.

Node 120A and node 120B may communicate with multihoming management system 130 through network 110. In one embodiment, node 120A may be a sender system and node 120B may be a receiver system, and nodes 120A and 120B may be collectively referred to as nodes 120. Nodes 120 generally include devices and modules that can transmit or receive data. For example, nodes 120 may include one or more of the following: input safety controller (e.g., a remote emergency stop device), an output safety controller (e.g., an emergency stop base module), a system under control, a communication hub, a control system (e.g. for managing one or more systems under control), a computing device (e.g., wearable device, an embedded device, an implanted device, a medical computing device, a mobile device, a ser, a laptop, a desktop, etc.), a network node (e.g., a router, a network edge device, etc.). Specifically, a system-under-control can be any suitable class of system to be controlled by another system (e.g., an output safety controller, a control system, etc.). Examples of systems-under-control include robots, vehicles (e.g., autonomous, semi-autonomous, etc.), industrial systems (e.g., manufacturing systems, farming systems, construction systems, waste processing systems, power systems, power generators, environmental control systems, military systems, transportation systems, etc.), home systems (e.g., HVAC, home automation, etc.). A system-under-control can be a terrestrial system, or a space system (e.g., satellite, spacecraft, missile, space probe, space station, etc.).

Nodes 120 may also include network interfaces for communicating with other nodes via network 110. For example, a sender system 120A may transmit data to the receiver system 120B through multiple interfaces. A network interface (or interface) may be a connection point that transmits data to another interface through interface devices. An interface is usually associated with an interface device such as software, devices, hardware devices, wired interface device, wireless interface device, radio transmitting device (e.g. receiver, transmitter, transceiver), or a combination thereof. The connection between one interface and another may be referred to as a link. Each node 120 may include one or more interfaces and multiple links may be used to transmit various classes of data between nodes 120. Each interface device can have one or more of characteristics and configurable parameters. Characteristics and parameters can include one or more of latency, operating power, power consumption, bandwidth, operating frequency, wavelength, radio frequency modulation type, etc. However, interface devices can have any suitable characteristics and parameters.

Each node 120 can include two or more interface devices having same or similar characteristics (e.g., a WiFi and an LTE interface, two LTE interfaces, two WiFi interfaces, etc.). In a first example, a node can include multiple copies of the same (or similar) interface device to provide redundancy (e.g., hardware redundancy). In a second example, a node can include multiple copies of the same (or similar) interface device to provide dedicated communication for a plurality of other nodes. In the second example, a node can include a separate WiFi hardware device for communication with each of a plurality of other nodes. Interface devices can include interface devices for multi-channel communication with other nodes, and optionally at least one network interface for communication via one or more networks (e.g., a public network, a private network, etc.). In an example, a first set of interface devices can include wireless interfaces, whereas a second set of interface devices can include a wired interface. In some implementations, at least one interface device is used to receive configuration information for performing one or more of link monitoring, link selection, and link transition.

Nodes 120 can include one or more of a processing unit, a memory, a storage device, an interface selection module, an input device (e.g., a keypad, keyboard, mouse, wand, touch input device, microphone, camera, etc.), an output device (e.g., a display, a haptic device, speaker, a light, an emitter etc.). One or more components of a node can be coupled (e.g., communicatively, electrically, etc.) via a bus.

In one embodiment, data transmitted between the nodes 120 may be categorized into multiple data classes (classes) and each class of data may be associated with a set of requirements demanding a quality of link used for transmitting the particular type of data. In one embodiment, classes of data may include one or more of the following: safety critical data (or functional safety data), real-time control critical data, control critical data, and informational data, which are discussed in further detail below.

Safety critical data generally include data whose latency and integrity (e.g. accuracy of data transmission) should be maintained at a high level for a system under control to operate safely. The high level may be determined based on regulatory requirements. For example, functional safety requirements mandate that undetectable error in safety messages be below a certain threshold, allowing for an extremely small amount of undetectable error. To illustrate, safety critical data may be a signal sent from an emergency stop device indicating that a robot should stop moving immediately; corruption of such a signal could cause severe harm, in that an emergency stop might not be effective if the signal were to be corrupted. As a result, it is crucial to maintain reliable connection (e.g. low latency and high reliability) for transmitting safety data.

Safety messages are further disclosed in commonly owned U.S. patent application Ser. No. 17/192,657 entitled “Secure Wireless Communication of Robotic Safety State Information”, which was filed on Mar. 4, 2021, which is hereby incorporated by reference in its entirety for all purposes. In one embodiment, multihoming management system 130 may determine whether the data (also referred to as a message) to transmit is safety critical data based on whether safety information is indicated in a safety payload or safety header of a message. Safety payload or safety header may include information such as an indication of a safety state (e.g. safety critical status) of the data to transmit. Safety critical data may also be identified based on whether the message includes safety information based on content of the message.

Real-time control critical data may include data containing command information for the system under control, and the command information may be expected to result in direct and immediate action by the system under control. An example of real-time control critical data may be instructions sent to robots to pour molten metal in foundry responsive to detecting the molten metal reaching a certain temperature. Control critical data may include data containing command information for the system under control to perform certain operations in future. For example, control critical data may be instructions to an agricultural robot to control humidity or sunlight in a greenhouse according to temperature or sunlight throughout a year. Control critical data may not have a strict requirement for connectivity (e.g., latency level), such as the same onerous requirements as functional safety data, but may still require connectivity meets a threshold baseline minimum, that threshold being lower than that for safety data.

Informational data may contain status and event information for or about the system under control. Informational data is less time sensitive and may tolerate network congestion and drops in data packets because informational data does not directly affect functionalities of the system under control. Incidents such as delivery latency, network congestions, drops in data packets in informational data may not cause changes in behavior of the system under control. For example, informational data may be how long the machine has been running or the remaining battery level of a machine.

In one embodiment, data to transmit may be categorized into the different data classes by reading header information associated with the data. The header information may specific a data class that the data belongs to. In another embodiment, content of data may be analyzed to determine a data class. For example, data may be categorized based on a set of pre-determined rules (such as key words or format of data) based on data content. As another example, messages with data content including an indication that demands a safe state (e.g. safety critical) may be categorized into a data class with higher priority (such as safety critical data class or real-time control critical data class), whereas normal heartbeat messages may be categorized into a data class with low priority such as control critical data class or informational data class. Classes of data may also be identified by information associated with source or destination of the message, such as an address of the source/destination or a type of the source/destination. Data header or data content may also include a data class flag that may be used for recognizing the various data classes.

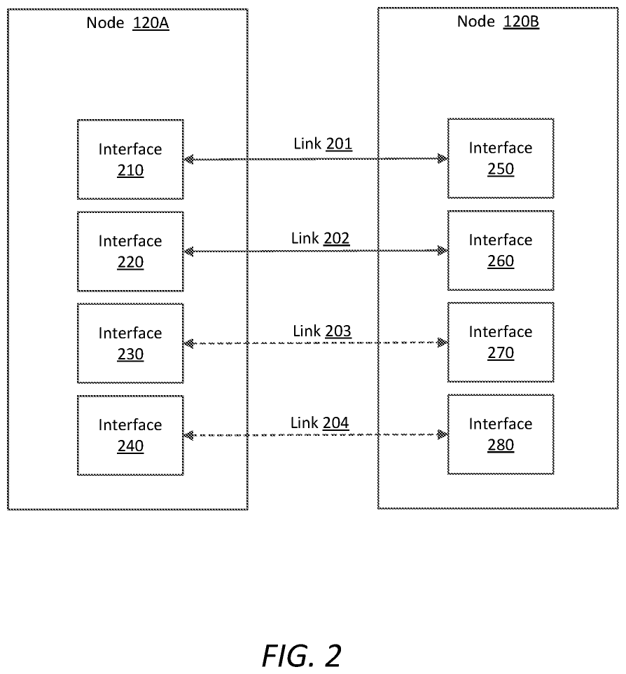

In one embodiment, different classes of data may be transmitted using different links. For example, safety data often require the highest level of liability requirement among the different classes of data, such that, responsive to e.g., sending an emergency stop signal to a machine, the safety information should be transmitted to the machine with high integrity and low latency. On the other hand, informational data is often associated with the lowest requirement, as the information data often contains status information that does not cause changes in machine behavior. Further detail regarding nodes 120A, interfaces, and the links connecting the interfaces are discussed in further detail in accordance with FIG. 2.

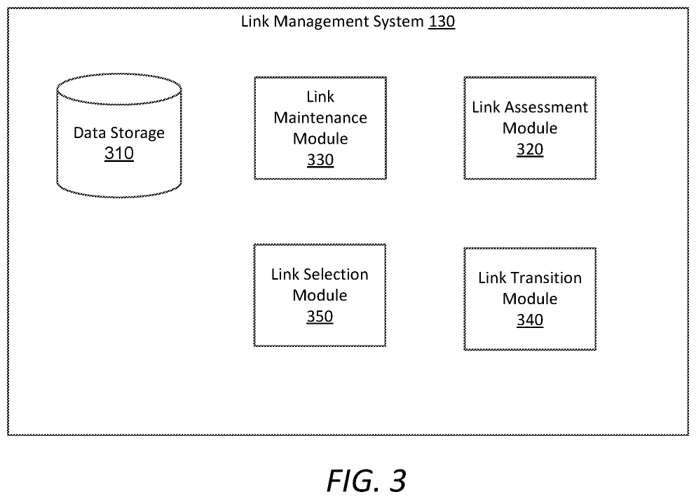

Multihoming management system 130 manages links between nodes 120. In one embodiment, multihoming management system 130 maintains and monitors a set of links between nodes 120 for data transmission. The set of links may include active links and backup links, where the active links are in use for data transmission and the backup links may be monitored and are standing by for potential link transition. In one embodiment, multihoming management system 130 may determine fitness metrics for a class of data based on a combination of one or more of parameters including link status, signal strength, recent average message error rate, recent average message latency, current message power efficiency, current message monetary cost, system configuration, timing of last interface change, etc. Multihoming management system 130 may periodically or aperiodically monitor quality of links between the nodes 120 and manages links transitions responsive to changes in link quality. For example, responsive to quality degradation of a link that is transmitting safety data, multihoming management system 130 may perform link transition and activate a backup link that meets the set of requirements for transmitting safety data. Multihoming management system 130 may also control link transition such that the link transition does not affect safety or real-time machine functions. Multihoming management system 130 is discussed in further detail below in accordance with FIG. 3.

FIG. 2 shows one exemplary system including a sender system 120A, a receiver system 120B, and various interfaces and links used for communication between the sender system 120A and the receiver system 120B. The sender system 120A may include multiple interfaces such as interfaces 210-240 and the receiver system 120B may also include multiple interfaces such as interfaces 250-280. Interfaces may communicate with each other through links such as links 201-204. In the example illustrated in FIG. 2, link 201 and 202 are active links that are in use for transmitting data (active links are illustrated with solid arrowed lines) and links 203 and 204 are backup links illustrated with dotted arrowed lines. In one embodiment, backup links may include warm backup links and cold backup links, where warm backup links are monitored by sending polling messages and cold backup links may not be monitored or monitored less frequently than the warm backup links. Warm backup links may be monitored by the multihoming management system 130 for status information such as link status, signal strength, recent average message error rate, recent average message latency, current message power efficiency, current message monetary cost, system configuration, timing of last interface change, etc. The warm backup links may not be currently in use for data transmission but are ready for link transition. Cold backup links may not be actively monitored and are not in use for data transmission but may be connected or activated if needed. In some variations, determining whether to select a new communication link includes determining whether to select a link in a cold backup state (e.g., by using characteristics and/or parameters of the interface device that provides the cold backup link). In some variations, determining whether to select a new communication link includes determining whether to select a link in a warm backup state. In some variations, determining whether to select a new communication link includes determining whether to select a link provided by a disabled interface device by using characteristics and/or parameters of the available interface devices. If the selected backup communication link is in a cold backup state, the backup link is established (thereby transitioning the link to a warm backup state), and the first node sends the link transition notification via the selected backup communication link after the backup link is established.

As illustrated in FIG. 2, multiple active links such as links 201 and 202 may be used for data transmission for different classes of data. In one embodiment, each link may be used for transmitting one class of data or multiple classes of data, and each class of data may be transmitted over one or more links. To illustrate with a concrete example as illustrated in FIG. 2, link 201 may be Wi-fi which has a high bandwidth but may be unstable, and link 202 may be ISM which is reliable but may have a relative narrow bandwidth. In one embodiment, multihoming management system 130 may determine to send safety data over both link 201 and link 202 and send real-time control critical data over link 201. Link 203 may be a warm backup link that transmits data through LTE. Because it may be power consuming to connect through LTE, multihoming management system 130 may send status poll messages periodically to the link 203 to make sure that the link is connected (e.g. every 2 seconds). Responsive to changes such as degradation in quality for links 201 and 202, multihoming management system 130 may activate link 203 for data transmission despite that link 203 may not be power efficient. In one embodiment, each link 201-204 is periodically monitored for quality of connection. Multihoming management system 130 may determine fitness metrics for each link 201-204 based on the class of data to transmit. Multihoming management system 130 may further select one or more links for data transmission based on the fitness metrics. Further details regarding link assessment and link selection are discussed in detail in accordance with FIG. 3.

FIG. 3 shows a block diagram of the multihoming management system 130 according to one embodiment. In one embodiment, the multihoming management system 120 includes a data storage 310 that stores information associated with nodes 120, a link assessment module 320 that determines fitness metrics based on a set of parameters, a link maintenance module 330 that monitors the status of links, a link selection module 350 that selects a links based on fitness metrics, and a link transition module 340 that manages link transitions.

Data store 310 may store information associated with nodes 120, such as information associated with interfaces included in nodes 120, links between nodes, and requirements associated with different classes of data to be transmitted between nodes. In one embodiment, data store 310 may store recent average message error rate and long-term message error rate for a set of links. In one embodiment, other summary statistics (such as, maximum, minimum, median, average of top 5 error rates, etc.) calculated based on historical message errors rate may also be stored in data store 310 and may be used for fitness evaluation. Recent average message error rate may be an average error rate in recent data transmission (e.g. in a recent time period or in the most recent 50 messages transmitted). Long-term message error rate may be an average error rate in data transmission in a longer period of time. The error rate may be determined by performing data validation techniques (such as CRC i.e. Cyclic Redundancy Check, checksums, and decryption of known signatures) to validate data transmission. Data store 310 may also store recent average message latency and long-term message latency for the set of links, where recent average message latency may be an average latency in a pre-determined most recent time period and long-term message latency may be an average latency in a longer pre-determine time period. In one embodiment, data store 310 may store system configuration information of various interfaces associated with the set of links. For example, for a link that transmits data through Wi-fi, data store may store information such as IP address, band, frequency and network name. Data store 310 may also store information such as timing of last interface change for the respective link, which may be taken into account when determining link transition. In one embodiment, data store 310 may store other information associated with nodes, links and interfaces such as link status, signal strength, and power efficiency, etc.

Link maintenance module 330 may monitor status of the active links and backup links by sending status poll messages to the links periodically. In one embodiment, link maintenance module 330 may send status poll messages to links at pre-determined regular intervals to collect information associated with the links. In another embodiment, link maintenance module 330 may also send status poll messages responsive to triggers such as fluctuations in network performance (e.g. network starting to deteriorate but not fully deteriorated). The information to collect may include one or more of the following: link status (e.g. connected or disconnected), signal strength (e.g. RSSI: Received Signal Strength Indicator), recent average message error rate, recent average message latency, current message power efficiency (e.g. power consumption to deliver a message), bandwidth, price per byte of data, system configuration, timing of last link transition.

In one embodiment, the frequency for sending status poll messages may be pre-determined or determined by a machine learning algorithm. In one embodiment, the machine learning algorithm may take a set of parameters as input, the set of parameters may include link state (e.g. backup or active), power consumption for status polling, and timing of last interface change. The machine learning algorithm may determine a frequency that minimize computational cost resulting from status polling while maintaining performance of the link. The status polls may be bi-directional which may help to gather information for both data transmitting in and transmitting out for the link.

The frequency can be configured for all links, for individual links, for all data classes, for individual data classes, etc. In an example, status poll messages can be sent over different links at different frequencies. In an example, for each link, the frequency can be configured based on the data classes that can be transmitted via the link. However, the frequency of status poll messages can be configured in any suitable manner. In some implementations, the frequency of the status poll messages can be configured to optimize for one or more of: speed in detecting changing link performance conditions; power consumption; and link performance characteristics. For example, for a fast link (e.g., a WiFi or LTE link), the frequency of the status poll messages can be higher, as compared with a low bandwidth link (e.g., an ISM link). However, the frequency of status poll messages can be configured to optimize for any suitable factor. As an example, frequency of transmission of safety critical data can be increased if performance of the active communication link for the safety critical data decreases. As another example, reduction in performance of the active communication link can indicate slower safety response times, and thereby cause a controller that generates vehicle control commands to operate the vehicle at a slower speed to account for the reduction in safety response time. However, generation data to be transmitted at can be otherwise controlled based on information generated during the monitoring.

Link maintenance module 330 may send status poll messages to different links with different polling frequencies. The polling frequency may depend on various factors associated with the links and the classes of data being transmitted. Link assessment module 130 may account for various factors when determining polling frequency such as power consumptions and link performance characteristics. For example, a backup link may be polled less frequently than links that are currently in use for transmitting safety and real-time control critical data. As a more concrete example, a backup link may be an LTE link that has a high power-consumption and an active link may be a Wi-fi link that is more power efficient. Link assessment module 130 may send poll messages to the LTE link with a longer time interval (e.g. every 2 seconds) while sending poll messages to the Wi-fi link with a shorter time interval (e.g. every 0.1 second).

Link assessment module 320 may determine fitness metrics for each link based on a set of parameters associated with the links and interfaces. The fitness metrics may be determined based on information received from link maintenance module 330 and information stored in data store 310. The parameters used to determine fitness metrics may include one or more of the following: link status (e.g. connected or disconnected), signal strength (e.g. RSSI: Received Signal Strength Indicator), recent average message error rate, recent average message latency, current message power efficiency (e.g. power consumption to deliver a message), bandwidth, price per byte of data, system configuration, timing of last link transition, a result of a comparison between recent average message error rate and a typical average message error rate, a result of a comparison between recent average message latency and a typical average message latency, minimum link quality, minimum link health, minimum signal strength (e.g., RSSI), maximum recent average message error rate, maximum recent average message latency, minimum bandwidth, maximum current message power usage (e.g., how much power is consumed to deliver a message), maximum current message monetary cost, and maximum current link monetary cost. In one embodiment, link assessment module 320 may determine fitness metrics for each class of data based on different requirements associated with each class of data. Different classes of data may have different demands for quality of service. For example, in the determination of fitness metrics for safety data, parameters such as signal strength, error rate, and latency may weigh more than parameters such as power consumption or monetary cost (e.g. based on bytes of data transmitted) because in the transmission of safety data, incidents such as drops in data, error in data transmission, and delay caused by congestion in network or latency may lead to failure in successful data transmission. In determination of fitness metrics for informational data, which does not have a strict requirement for latency or bandwidth, parameters such as power efficiency and monetary cost may weigh more than error rate or latency. In one embodiment, link assessment module 320 may determine a combination of parameters for calculating fitness metrics for each class of data. The combination of parameters may be pre-determined or may be determined based on a machine learning algorithm. The combination of parameters is determined dynamically based on the parameters.

In one embodiment, link assessment module 320 may determine fitness metrics for a link based on a mode of operation. A mode of operation may include local mode wherein sender system 120A may control one machine such as receiver system 120B (or a limited number of machines within a certain range of distance) and another mode of operation may be a global mode that controls a larger number of machines in a wider range of distance (e.g. machines in a level of a facility). For example, link assessment module 320 may determine a high fitness metric for a link that uses Bluetooth based on a local mode of operation, and may determine that a link that uses LTE is associated with a high fitness metrics based on a global mode of operation. Link assessment module 320 may also determine fitness metrics for a link based on information associated with the sender system 120A and the receiver system 120B. For example, if the sender system 120A or the receiver system 120B is low in battery, link assessment module 320 may determine a low fitness metrics for links that consume more battery power (such as LTE).

Link selection module 350 may select a link from a set of links to be an active link based on fitness metrics determined by link assessment module 320. In one embodiment, link selection module 350 may select a link for transmitting a class of data based on the fitness metrics for the specific type of data. Link selection module 350 may select a link as a startup link for starting to transmit a set of data or may select a link from backup links as a new active link in a link transition process. Selecting a link (e.g., for all data, for a particular data class, etc.) can include comparing fitness metrics for each link with link selection parameters. If the link metrics satisfy the link selection parameters, the link can be selected. In some variations, more than one link can satisfy the link selection parameters, and a single link can be selected based on a priority assigned to each link. A priority can be assigned to a link based on one or more of a pre-configured priority, a matching score assigned to the link (e.g., based on a predictive model, based on a number of matching link selection parameters, based on a priority assigned to matching link selection parameters, etc.), system state, and the like. However, priority can be assigned to a link in any suitable manner. Link transition is discussed in further detail below in accordance with the link transition module 340.

Link selection parameters can include thresholds for link selection metrics (generated at S220), or any other suitable parameter. In some variations, link selection parameters include one or more conditional rules. Conditional rules can include rules that are satisfied based on system state. Conditional rules can be defined for one or more interface devices. In some variations, if a conditional rule of an interface device for a link is not satisfied, then the link is not selected for use as an active link. In some implementations, a conditional rule for an interface device is satisfied if a current system state matches a system state defined by the conditional rule. System states can identify interface devices that are enabled for data transmission on the node. In a first example, a conditional rule for an interface device can define a permissible system state that includes a list of other interface devices that are permitted to be enabled when the interface device is also enabled. The permissible system state can be defined to reduce radio interference among interface devices, to optimize for power efficiency, to optimize for monetary cost efficiency, to optimize for run time, to optimize for performance, to optimize for safety, to optimize for user experience, and the like. However, the permissible system state can be otherwise defined.

Link transition module 340 may determine and perform link transitions responsive to changes in link quality. In one embodiment, link transition module 340 may determine to perform link transition based on fitness metrics generated by link assessment module 320. For example, link transition module 340 may receive information from link assessment module 320 that the quality of a first link used for transmitting safety data degraded and the signal strength of the link no longer meets the requirement associated with transmitting safety data. Link transition module 340 may determine to activate a backup link for transmitting safety data. Link transition module 340 may determine, based on fitness metrics generated by link assessment module 340, a backup link to activate.

In one embodiment, link transition module 340 may perform several steps that help ensure data transmission is not interrupted during link transition such that functions of machines are not interrupted due to change of links. For example, link transition module 340 may receive from link assessment module 320 that a backup link is selected as a new active link. The link transition module 340 may first send an indication to the selected backup link, notifying the backup link is selected as a new active link. The link transition module 340 may then instruct the backup link to start transmitting data, while the old active link is still used to transmits the same data. The receiving nodes may determine that two copies of the same data are received and may send an indication over the new active link that the link transition process is complete. The sender system may stop sending data over the old active link and move the old active link to backup status. The old active link (now in backup status) may be monitored by link maintenance module 330 by sending status poll messages, such that when quality of the old link is detected to return to normal, the old link may be reactivated and the new active link may be moved back to backup status.

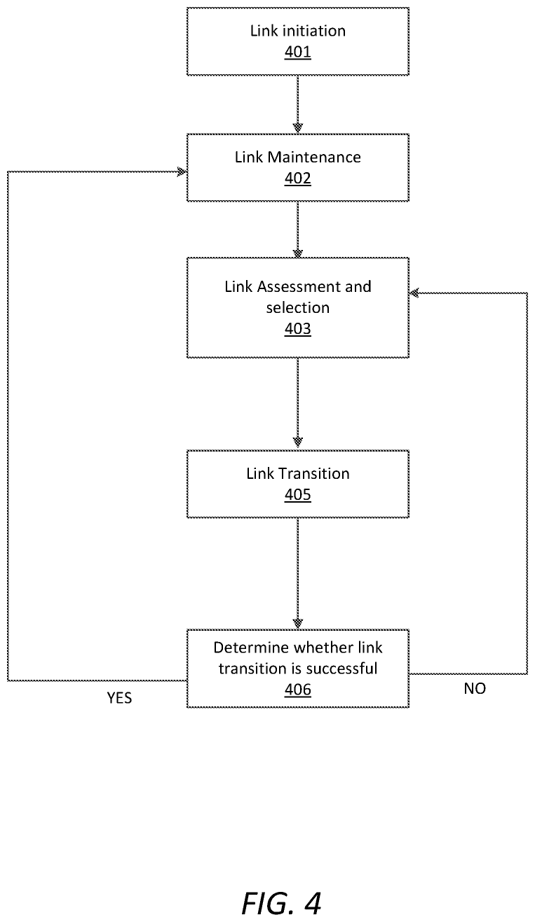

FIG. 4 shows a flow chart illustrating an exemplary process for initiating a link and selecting a link for link transition corresponding to the various modules in the multihoming management module 130. In one embodiment, the process may be an iterative process as illustrated in FIG. 4. The process illustrated in FIG. 4 starts with a link initiation 401 process. In some variations, establishing a communication link includes performing a signaling process according to a communication protocol to establish a communication session. In some variations, establishing a communication link includes configuring an interface device of the first node to communicate via a first radio frequency (and optionally, in accordance with one or more first radio transmission parameters). Establishing the communication link can optionally include configuring an interface device of the second node to communicate via the first radio frequency (and optionally, in accordance with the first radio transmission parameters). Multiple communication links can be established between the first node and the second node. In some variations, the first node (e.g., 120A) establishes at least a communication link with the second node (e.g., 120B) by using a second interface device included in the first node. Further communication links can be established by using the interface devices included in the nodes. In one embodiment, link maintenance module 330 may perform a link maintenance 402 process by sending status poll messages to a set of links and retrieve information such as signal strength, latency, error rate, power consumption, etc. The retrieved information may be sent to link assessment module 320 and link selection module 350 for link assessment and selection 403, where fitness metrics are determined for the links based on requirements for transmitting various classes of data and one or more links are selected as active links to transmit one or more classes of data. Responsive to changes in quality of links monitored by link assessment module 320, a link transition 405 process may be performed by the link transition module 340. Link transition module 340 may determine 406 whether the link transition is successful. Responsive to a failed link transition process, link assessment module 320 and link selection module 350 may perform assessment again and select another link to activate. On the other hand, responsive to a successful link transition, link maintenance module may continue to monitor status of the links including the new active link and the old active link (which is now a backup link) by sending polling messages. In one embodiment, the old active link may be closely monitored, and the old active link may be reactivated responsive to quality of the link returning to normal level.

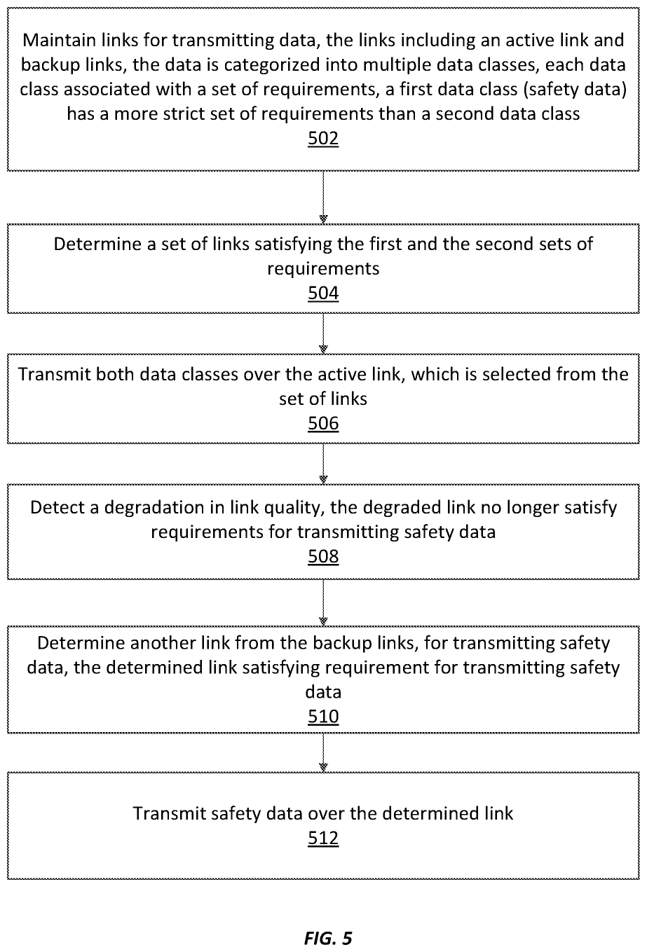

FIG. 5 illustrates an exemplary process for dynamically managing links between nodes 120 through the modules in a multihoming management system 130. The process may start with the multihoming management system 130 maintaining 502 a plurality of links for transmitting a set of data between a first node and a second node. The links may include an active link and a set of backup links. Data to transmit may be categorized into multiple data classes and each data class is associated with a set of requirements for data transmission. The data classes may include a first data class that is safety data and a second data class that has a lower requirement for latency level. Link assessment module 320 may determine 504 a set of links that satisfy the first and second sets of requirements for transmitting both data classes, and link selection module 350 may select one link as active link for data transmission 506. Link maintenance module 330 may periodically monitor status of the links and may detect 508 a degradation in link quality for the active link. The degraded link quality may no longer satisfy requirements for transmitting safety data. The link assessment module 320 and link selection module 350 may determine 510 a second link from backup links for transmitting the safety data, where the second link satisfies the requirement for transmitting safety data. Link transition module 340 may activate the selected second link and instruct the second link to transmit safety data.

### Additional Considerations

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

In this description, the term “module” refers to a physical computer structure of computational logic for providing the specified functionality. A module can be implemented in hardware, firmware, and/or software. In regards to software implementation of modules, it is understood by those of skill in the art that a module comprises a block of code that contains the data structure, methods, classes, header and other code objects appropriate to execute the described functionality. Depending on the specific implementation language, a module may be a package, a class, or a component. It will be understood that any computer programming language may support equivalent structures using a different terminology than “module.”

It will be understood that the named modules described herein represent one embodiment of such modules, and other embodiments may include other modules. In addition, other embodiments may lack modules described herein and/or distribute the described functionality among the modules in a different manner. Additionally, the functionalities attributed to more than one module can be incorporated into a single module. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices of a system, loaded into memory, and executed by the one or more processors of the system's computers.

The operations herein may also be performed by an apparatus. This apparatus may be specially constructed for the required purposes, or it may comprise a general-purpose computer selectively activated or reconfigured by a computer program stored in the computer. Such a computer program may be stored in a computer readable storage medium, such as, but is not limited to, any class of disk including optical disks, CD-ROMs, read-only memories (ROMs), random access memories (RAMs), magnetic or optical cards, or any class of media suitable for storing electronic instructions, and each coupled to a computer system bus. Furthermore, the computers referred to in the specification may include a single processor or may be architectures employing multiple processor designs for increased computing capability.

The algorithms presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

As used herein, the word “or” refers to any possible permutation of a set of items. Moreover, claim language reciting ‘at least one of’ an element or another element refers to any possible permutation of the set of elements.

Although this description includes a variety of examples and other information to explain aspects within the scope of the appended claims, no limitation of the claims should be implied based on particular features or arrangements these examples. This disclosure includes specific embodiments and implementations for illustration, but various modifications can be made without deviating from the scope of the embodiments and implementations. For example, functionality can be distributed differently or performed in components other than those identified herein. This disclosure includes the described features as non-exclusive examples of systems components, physical and logical structures, and methods within its scope.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method comprising:
maintaining a plurality of links for transmitting a set of data between a first node and a second node, the plurality of links including an active link and a set of backup links, wherein the set of data is categorized into one or more data classes, wherein a first class of data is functional safety data associated with a first set of requirements that require a latency level below a first threshold and wherein a second class of data is associated with a second set of requirements that require a latency level below a second threshold that is higher than the first threshold;
determining a set of links from the plurality of links that satisfy the first set of requirements and the second set of requirements;
transmitting both the first class of data and the second class of data over the active link selected from the set of links;
detecting a degradation in a quality of the link, wherein the degraded quality does not satisfy the latency level specified in the first set of requirements, the degraded quality satisfying the second set of requirements;
determining a second link, from the set of backup links, for transmitting the first class of data, the second link satisfying the latency level specified in the first set of requirements; and
transmitting the first class of data using the second link.

2. The method of claim 1, further comprising:
determining fitness metrics for each link of the set of backup links, the fitness metrics determined based on a set of parameters, wherein the set of parameters is determined based on the first set of requirements, and wherein determining the second link for transmitting the first class of data is further based on the fitness metrics.

3. The method of claim 2, wherein the set of parameters include one or more of the following: signal strength, latency, error rate, power efficiency, system configuration, and timing of last link change.

4. The method of claim 1, further comprising:
determining to transmit the second type of data over the active link based on a fitness metric of the active link with degraded quality, wherein the degraded quality satisfies the second set of requirements and the is transmitted and where in the fitness metric is determined based on the second set of requirements for the second type of data.

5. The method of claim 1, further comprising transmitting a third type of data through a third link based on a fitness metric determined based on computational cost and power efficiency, wherein the third type of data is not associated with a latency requirement.

6. The method of claim 1, wherein the fitness metrics are monitored regularly with pre-determined time intervals.

7. The method of claim 6, wherein the pre-determined intervals vary based on data classes and link status.

8. The method of claim 1, wherein the set of backup links includes one or more warm backup links and one or more cold backup links, wherein the one or more warm backup links are monitored regularly and the one or more cold backup links are not monitored.

9. The method of claim 1, wherein the fitness metrics are further determined based on an operation mode, the operation mode indicating one or more of a range of distance and a number of machines affected under the operation mode.

10. The method of claim 1, where in the first set and the second set of requirements further include one or more of the following: connection stableness, bandwidth, error rate, and power consumption.

11. A non-transitory computer-readable storage medium storing executable computer instructions that, when executed by one or more processors, cause the one or more processors to perform operations, the executable computer instructions comprising instructions to:
maintain a plurality of links for transmitting a set of data between a first node and a second node, the plurality of links including an active link and a set of backup links, wherein the set of data is categorized into one or more data classes, wherein a first class of data is functional safety data associated with a first set of requirements that require a latency level below a first threshold and wherein a second class of data is associated with a second set of requirements that require a latency level below a second threshold that is higher than the first threshold;
determine a set of links from the plurality of links that satisfy the first set of requirements and the second set of requirements;
transmit both the first class of data and the second class of data over the active link selected from the set of links;
detect a degradation in a quality of the link, wherein the degraded quality does not satisfy the latency level specified in the first set of requirements, the degraded quality satisfying the second set of requirements;
determine a second link, from the set of backup links, for transmitting the first class of data, the second link satisfying the latency level specified in the first set of requirements; and
transmit the first class of data using the second link.

12. The non-transitory computer-readable storage medium of claim 11, wherein the instructions further comprise instructions to:
determine fitness metrics for each link of the set of backup links, the fitness metrics determined based on a set of parameters, wherein the set of parameters is determined based on the first set of requirements, and wherein determining the second link for transmitting the first class of data is further based on the fitness metrics.

13. The non-transitory computer-readable storage medium of claim 11, wherein the set of parameters include one or more of the following: signal strength, latency, error rate, power efficiency, system configuration, and timing of last link change.

14. The non-transitory computer-readable storage medium of claim 11, wherein the instructions further comprise instructions to:
determine to transmit the second type of data over the active link based on a fitness metric of the active link with degraded quality, wherein the degraded quality satisfies the second set of requirements and the is transmitted and where in the fitness metric is determined based on the second set of requirements for the second type of data.

15. The non-transitory computer-readable storage medium of claim 11, wherein the fitness metrics are monitored regularly with pre-determined time intervals that vary based on data classes and link status.

16. A system comprising:
memory with instructions encoded thereon; and
one or more processors that, when executing the instructions, perform operations comprising:
maintaining a plurality of links for transmitting a set of data between a first node and a second node, the plurality of links including an active link and a set of backup links, wherein the set of data is categorized into one or more data classes, wherein a first class of data is functional safety data associated with a first set of requirements that require a latency level below a first threshold and wherein a second class of data is associated with a second set of requirements that require a latency level below a second threshold that is higher than the first threshold;
determining a set of links from the plurality of links that satisfy the first set of requirements and the second set of requirements;
transmitting both the first class of data and the second class of data over the active link selected from the set of links;
detecting a degradation in a quality of the link, wherein the degraded quality does not satisfy the latency level specified in the first set of requirements, the degraded quality satisfying the second set of requirements;
determining a second link, from the set of backup links, for transmitting the first class of data, the second link satisfying the latency level specified in the first set of requirements; and
transmitting the first class of data using the second link.

17. The system of claim 16, the operations further comprising:
determining fitness metrics for each link of the set of backup links, the fitness metrics determined based on a set of parameters, wherein the set of parameters is determined based on the first set of requirements, and wherein determining the second link for transmitting the first class of data is further based on the fitness metrics.

18. The system of claim 16, wherein the set of parameters include one or more of the following: signal strength, latency, error rate, power efficiency, system configuration, and timing of last link change.

19. The system of claim 16, the operations further comprising:
determining to transmit the second type of data over the active link based on a fitness metric of the active link with degraded quality, wherein the degraded quality satisfies the second set of requirements and the is transmitted and where in the fitness metric is determined based on the second set of requirements for the second type of data.

20. The system of claim 16, wherein the fitness metrics are monitored regularly with pre-determined time intervals that vary based on data classes and link status.
